(19) United States
(12) Patent Application Publication
(10) Pub. No.: US 2009/0027796 A1
(43) Pub. Date: Jan. 29, 2009

(54) INFORMATION RECORDING DEVICE AND CONTROL METHOD THEREFOR

(75) Inventor: Tatsuo Nitta, Ome-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 12/177,250

(22) Filed: Jul. 22, 2008

(30) Foreign Application Priority Data
Jul. 24, 2007 (JP) 2007-192280

(51) Int. Cl. G11B 5/09

(52) U.S. Cl. 360/31; 360/69; 369/47.32; 711/103; G9B/5.033

(57) ABSTRACT

According to one embodiment, an information recording device comprises, when writing asynchronous data not recorded in a disk-like recording medium among data recorded in a non-volatile memory by a control module, a setting module is configured to place priority order of writing the asynchronous data to the disk-like recording medium in response to a state of each recording area with the asynchronous data of the non-volatile memory recorded therein.

### CROSS-REFERENCE TO RELATED APPLICATIONS

This application is based upon and claims the benefit of priority from Japanese Patent Application No. 2007-192280, filed Jul. 24, 2007, the entire contents of which are incorporated herein by reference.

### BACKGROUND

1. Field

One embodiment of the invention relates to an information recording device which writes and reads information using a non-volatile semiconductor memory as a cache to and from a disk-like recording medium having a large capacity such as a hard disk, and a control method therefor.

2. Description of the Related Art

As in well known, a hard disk is an information recording medium having a large capacity and high reliability. In recent years, the hard disk has become widely used in many fields, for example, as a recording medium for a computer, video data, audio data, etc. The size of the hard disk has become compact so as to be mounted on a portable electronic device.

Therefore, in an information recording device that is intended to be made more compact by using the hard disk, the speed required to write and read data to and from the hard disk is increased by using a semiconductor memory capable of writing and reading data at high speed as a cache memory of the hard disk.

That is, this kind of information recording device performs data writing and reading to and from an external host device through the cache memory, performs data transfer to the hard disk through the cache memory, and therefore, increases the speed of data writing and reading operations as seen from the outside.

At present, by including a non-volatile memory as the cache for the hard disk in addition to the cache memory, the information recording device reduces the number of times of driving of the hard disk, namely the number of times of writing and reading of the data so as to reduce the consumption of battery power. Such an information recording device is referred to as a hard disk drive (HDD) compatible with a non-volatile (NV)-cache, and is standardized.

As regards the information recording device equipped with the non-volatile memory as the cache for the hard disk, for example, when a recording area of the non-volatile memory is almost full, the information recording device automatically writes the data recorded on the non-volatile memory to the hard disk and forms a free area on the non-volatile memory.

This kind of information recording device is configured to automatically write data at a predetermined timing, which is asynchronous data on the hard disk, namely data which does not coincide with the data recorded on the hard disk among the data recorded in the non-volatile memory.

Meanwhile, at present, a flash memory which has been widely used as a non-volatile memory tends to have low performance of data storage in comparison with the hard disk and to easily generate bit errors when performing data rewriting at the number of times not less than the defined number of times and when not using the flash memory for a long period of time. Therefore, it is important for the data recorded in the non-volatile memory to write on the hard disk as much as possible and to secure the safety.

However, since the foregoing data writing processing from the non-volatile memory to the hard disk is voluntarily performed inside the HDD, due to an external cause, for example, the provision of a command to require writing or reading the data from the host device, etc., the writing processing is frequently interrupted and it may take a long time until the entire processing is completed.

In this case, if the data recorded in an area where bit errors tend to occur in the non-volatile memory is not written to the hard disk and indefinitely remains in the non-volatile memory, there is every possibility of occurrences of bit errors in the data, which results in deterioration in the reliability of the data.

A configuration of a disk cache device using a flash EEPROM card as a cache of a hard disk device to detect data which has not been written from the flash EEPROM to the hard disk device and execute writing processing of the data is disclosed in Jpn. Pat. Appln. KOKAI Publication No. 11-45210.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a view depicting an embodiment of the invention and a block diagram for explaining an outline of an information recording device;

FIG. 2 is a view for explaining a recording area in a flash memory equipped with the information recording device of the embodiment;

FIG. 3 is a block diagram for explaining an example of a controller equipped with the information recording device of the embodiment;

FIG. 4 is a view for explaining an example of a processing operation of the information recording device of the embodiment;

FIG. 5 is a flowchart for explaining an example of the processing operation of the information processing device of the embodiment;

FIG. 6 is a view for explaining another example of the processing operation of the information recording device of the embodiment;

FIG. 7 is a flowchart for explaining another example of the processing operation of the information processing device of the embodiment;

FIG. 8 is a flowchart for explaining another example of the processing operation of the information processing device of the embodiment;

FIG. 9 is a flowchart for explaining another example of the processing operation of the information processing device of the embodiment;

FIG. 10 is a flowchart for explaining another example of the processing operation of the information processing device of the embodiment; and

FIG. 11 is a flowchart for explaining another example of the processing operation of the information processing device of the embodiment.

### DETAILED DESCRIPTION

Various embodiments according to the invention will be described hereinafter with reference to the accompanying drawings. In general, according to one embodiment of the invention, an information recording device comprises, when writing asynchronous data not recorded in a disk-like recording medium among data recorded in a non-volatile memory by a control module, a setting module is configured to place priority order of writing the asynchronous data to the disk-like recording medium in response to a state of each recording area with the asynchronous data of the non-volatile memory recorded therein.

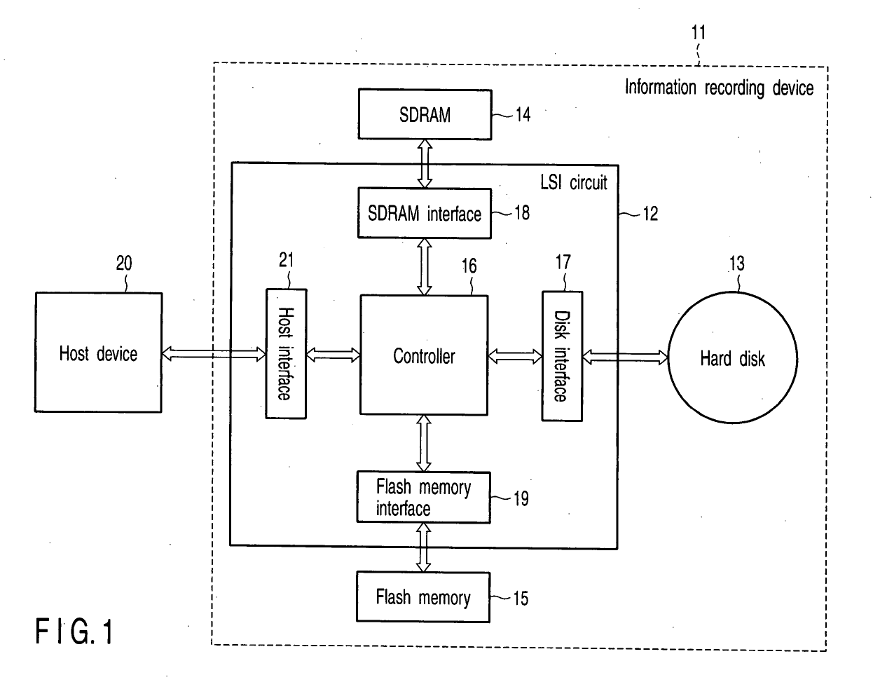

Hereinafter, an example of the invention will be described in detail with reference to the drawings. FIG. 1 shows an outline of an information recording device 11 to be explained in the embodiment. As regards the information recording device 11 to be explained here, a magnetic disk device such as an HDD compatible with a nonvolatile-cache (NV-cache) standardized by Non Volatile Cache Command Proposal for ATA 8, etc., is targeted.

The information recording device 11 includes a single chip large scale integrated (LSI) circuit 12 with various circuit blocks built-in. A hard disk 13 that is a disk-like recording medium having a large capacity, a synchronous dynamic random access memory (SDRAM) 14, a flash memory 15, etc., are connected to the LSI circuit 12.

Among of them, the SDRAM 14 functions as a buffer and is a cache memory for the hard disk 13. The buffer function is not limited to the SDRAM 14, for example, a static RAM (SRAM), etc., can be used. The flash memory 15 is a non-volatile memory (NV-cache) which functions as a cache for the hard disk 13.

In the case in which the information recording device 11 executes various kinds of processing operations, the LSI circuit 12 has a controller 16 to be a control module for integrally controlling the processing operations built-in. The LSI circuit 12 has a built-in disk interface 17 for connecting the controller 16 and the hard disk 13 to transfer data.

The LSI circuit 12 has an SDRAM interface 18 for connecting the controller 16 and the SDRAM 14 for data transfer, a flash memory interface 19 for connecting the controller 16 and the flash memory 15 for data transfer, a host interface 21 for connecting the controller 16 and an external host device 20 for data transfer, etc., built-in.

The host device 20, for example, is a personal computer (PC). When executing, for example, predetermined application software, the host device 20 may execute writing and reading of the data by using the information recording device 11, and may utilize the information recording device 11 as a storage destination of the finally acquired data.

When writing and reading the data to and from the information recording device 11, the host device 20 issues a command for requiring data writing or a command for requiring data reading to the information recording device 11. These commands are supplied to the controller 16 through the host interface 21 to be analyzed.

Thereby, the controller 16 may control the hard disk 13, the SDRAM 14 and the flash memory 15, etc., so as to write the data supplied from the host device 20 and to read the data for supplying to the host device 20. In this case, the controller 16 enables transferring the data among the hard disk 13, the SDRAM 14 and the flash memory 15 with one another.

More specifically, when writing the data supplied from the host device 20 to the hard disk 13, the controller 16 may select the following five routes (W1)-(W5) as the order of data writing.

(W1): The host interface 21→the controller 16→the disk interface 17→the hard disk 13.

(W2): The host interface 21→the controller 16→the SDRAM interface 18→the SDRAM 14→the SDRAM interface 18→the controller 16→the disk interface 17→the hard disk 13.

(W3): The host interface 21→the controller 16→the flash memory interface 19→the flash memory 15→the flash memory interface 19→the controller 16→the disk interface 17→the hard disk 13.

(W4): The host interface 21→the controller 16→the SDRAM interface 18→the SDRAM 14→the SDRAM interface 18→the controller 16→the flash memory interface 19→the flash memory 15→the flash memory interface 19→the controller 16→the disk interface 17→the hard disk 13.

(W5): The hosts interface 21→the controller 16→the flash memory interface 19→the flash memory 15→the flash memory interface 19→the controller 16→the SDRAM interface 18→the SDRAM 14→the SDRAM interface 18→the controller 16→the disk interface 17→the hard disk 13.

When the host device 20 reads the data from the hard disk 13 to the host device 20, the controller 16 may select the following five routes (R1)-(R5) as the order of data reading.

(R1): The disk interface 17→the controller 16→the host interface 21→the host device 20.

(R2): The disk interface 17→the controller 16→the SDRAM interface 18→the SDRAM 14→the SDRAM interface 18→the controller 16→the host interface 21→the host device 20.

(R3): The disk interface 17→the controller 16→the flash memory interface 19→the flash memory 15→the flash memory interface 19→the controller 16→the host interface 21→the host device 20.

(R4): The disk interface 17→the controller 16→the SDRAM interface 18→the SDRAM 14→the SDRAM interface 18→the controller 16→the flash memory interface 19→the flash memory 15→the flash memory interface 19→the controller 16→the host interface 21→the host device 20.

(R5): The disk interface 17→the controller 16→the flash memory interface 19→the flash memory 15→the flash memory interface 19→the controller 16→the SDRAM interface 18→the SDRAM 14→the SDRAM interface 18→the controller 16→the host interface 21→the host device 20.

The controller 16 determines and decides the forgoing order of the data writing and reading in response to, for example, instruction contents in a writing request command or reading request command supplied from the host device 20, a storage place of the data, a free capacity in the SDRAM 14 or the flash memory 15.

As regards the flash memory 15, in general, a NAND flash memory tends to be widely adopted. If the NAND flash memory is adopted, the speeds of the data writing and reading to and from the flash memory 15 frequently become slower than the speeds of the data writing and reading to and from the SDRAM 14.

Here, commands needed to explain the embodiment will be described among various commands which are set by the foregoing specification and which are executable by the information recording device 11. A first command specifies a logical block address (LBA) to write the data in the flash memory 15 among LBAs on the hard disk 13.

A second command specifies the LBA to write the data in the flash memory 15 in the same way as that of the first command, reads the data recorded at the relevant LBA from the hard disk 13, and requires writing the read data in the flash memory 15 at the same time.

The foregoing first and the second commands correspond to PI=0 and PI=1 of an Add LBA(s) to NV Cache Pinned Set in the aforementioned specification, and attribute information called pinned is attached to the LBA at which an instruction to store the data in the flash memory 15 is issued from the host device 20.

A third command specifies the LBA on the hard disk 13 and requires writing the data. When the third command is made from the host device 20, the controller 16 checks whether or not the attribute information of the pinned is associated with the LBA at which the writing is required. If the attribute information is associated with the LBA, the controller 16 executes writing in an area corresponding to the LBA at which the writing is required in the flash memory 15.

Conversely, if the attribute information of the pinned is not associated with the LBA at which the writing is required, the controller 16 decides to execute in accordance with its own determination whether the data should be written in the area corresponding to the specified LBA in the SDRAM 14 or the flash memory 15 or should be written the data at the specified LBA in the hard disk 13.

A fourth command specifies the LBA on the hard disk 13 to require reading the data. If the fourth command is made from the host device 20, when the area corresponding to the specified LBA has already been assigned to the flash memory 15 and it is determined that data newer than that of the hard disk 13 is stored in the area, the controller has to read the relevant data from the hard disk 13.

In contrast, if the same data is stored in the hard disk 13 and the flash memory 15, the controller 16 may read the relevant data from the area corresponding to the LBA from which the data is required to be read in the flash memory 15, and may read the relevant data from the specified LBA on the hard disk 13.

The area corresponding to the specified LBA has already been assigned to the flash memory 15; however, if the latest data is present on the hard disk 13, the controller 16 has to read the concerned data from the specified LBA on the hard disk 13. When reading the data from the hard disk 13, the controller 16 also determines whether or not the data should be cached in the SDRAM 14 or in the flash memory 15.

Like the aforementioned third and fourth commands, attribute information called unpinned is attached to the LBA, among the LBAs at which the data writing or reading has been required, in the LBAs with which pinned attribute information is not associated, the area is assigned on the flash memory 15 and the LBA at which the data has been written in the area on the assigned flash memory 15.

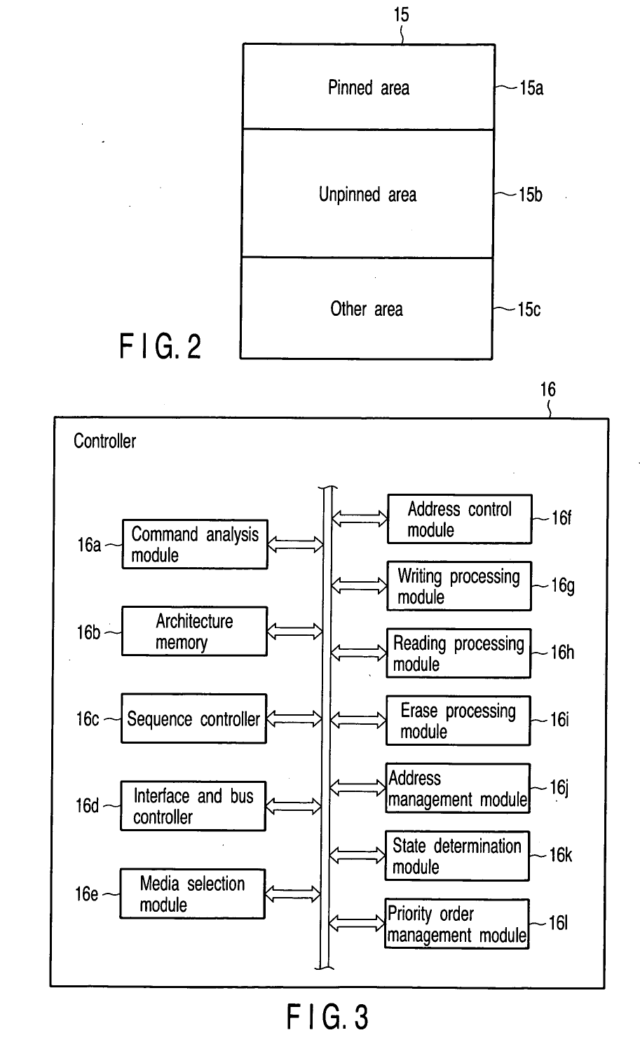

The LBA with the attribute information of the pinned attached thereto is called a pinned LBA, the area on the flash memory 15 corresponding to the pinned LBA is called a pinned area. The LBA with attribute information of an unpinned attached thereto is referred to as an unpinned LBA; the area on the flash memory 15 corresponding to the unpinned LBA is referred to as an unpinned area. Therefore, on the flash memory 15, as shown in FIG. 2, a pinned area 15a, an unpinned area 15b and other area 15c are formed.

When the recording area on the flash memory 15 becomes almost full, the controller 16 writes the data recorded on the flash memory 15 to the hard disk 13 then automatically forms free areas of a prescribed amount in the flash memory 15.

This processing is realized when the size of a free area in the flash memory 15 becomes smaller than a preset reference size, in accordance with a way that the controller 16 writes the data of a prescribed amount to the hard disk 13 from the area (unpinned area 15b) corresponding to the LBA with the attribute information of the unpinned attached thereto in the flash memory 15, and erases the written data to the hard disk 13 from the flash memory 15.

In this case, controller 16 determines and decides which area shifts the information stored therein to the hard disk 13, namely which area in the flash memory 15 forms free areas among the areas (unpinned area 15b) corresponding to the LBA with the attribute information of the unpinned attached thereto.

The controller 16 automatically writes the data which has become asynchronous data on the hard disk 13, namely the data which has not coincided with the data recorded on the hard disk 13 at prescribed timing.

Meanwhile, it has been well known that the flash memory 15 has a data storage performance which is lower than that of the hard disk 13, and easily poses bit errors if the flash memory 15 performs data rewriting of the number of defined times (e.g., one hundred thousands times) or if the flash memory 15 is unused for a long period of time.

An error correction code is added to the data to be written in the flash memory 15, and error correction processing based on the error correction code is applied to the data to be read from the flash memory 15. Further, the error correction code is added also to the data to be recorded on the hard disk 13, and the error correction processing based on the error correction code is applied to the data to be read from the hard disk 13. Usually, the error correction processing applied to the data to be recorded on the hard disk 13 adopts a system with an extremely high error correction ability in comparison with the error correction processing to be applied to the data to be recorded on the flash memory 15.

That is, the data to be recorded on the hard disk 13 has a dramatically higher reliability than that of the data to be recorded in the flash memory 15. Therefore, it is preferable for the data recorded in the flash memory 15 to be written to the hard disk 13 whenever possible, for the purpose of securing the safety.

However, the controller 16 should autonomously write the data from the flash memory 15 to the hard disk 13 when a processing request is not made from the outside. Therefore, for example, due to an external cause such that a command requiring data writing or reading is issued from the host device, the writing processing is frequently interrupted, and it may take a long time until the processing is completed perfectly.

In such a case, if the data, which is recorded in the area in which a bit error easily occurs in the flash memory 15, remains in the flash memory 15 without being written to the hard disk 13 for a long period of time, there is every possibility of generating a bit error in the data, which results in deterioration in the reliability of the data.

Therefore, in this embodiment, in writing the data from the flash memory 15 to the hard disk 13, as regards the data to be written from the flash memory 15 to the hard disk 13, the information recording device determines the state of the recording area on the flash memory 15 and places the order of priority so that the data is written to the hard disk 13 in order from the data recorded in the recording area with the worst state.

In this case, the state in the recording area on the flash memory 15 means, for example, kind of data, the number of times of error corrections (the number of error checks and corrections [ECC]), the number of times of erasing/writing (more specifically the number of the times of erasing). The information recording device determines that the recording areas with a large number of error corrections or large number of times of the erasing are poor states, and places the order of priority so that the data is written to the hard disk 13 in order from the data recorded in the recording area with the worst state. It should be noted that the erasing and writing of data with reference to the flash memory 15 are executed for areas that are referred to as blocks, and that the number of times the data erasing or data writing is performed is counted in units of blocks.

Thus, since the data is preferentially written to the hard disk 13 in order from the data recorded in the recording area with the worst state in the flash memory 15, it may be prevented that the data, which is recorded in the area in which a bit error easily occurs in the flash memory 15, remains in the flash memory 15 without being written to the hard disk 13 for a long period of time, writing processing of the data recorded in the flash memory 15 to the hard disk 13 is made efficient, the occurrence of data errors may be prevented as much as possible and the reliability of the data may be kept high.

FIG. 3 shows an example of the controller 16. The controller 16 includes a command analysis module 16a which decodes to analyze the command to be supplied from the host device 20. As a result of the analysis from the analysis module 16a, software in an architecture memory 16b is specified, and an operation procedure is set in a sequence controller 16c.

The sequence controller 16c controls the flow of information through an interface and a bus controller 16d. For instance, when the information is written or read, a media selection module 16e specifies the hard disk 13, the SDRAM 14 or the flash memory 15 and also an address control module 16f specifies a writing address or a reading address.

In writing the information, a writing processing module 16g executes transfer processing of the writing information. In reading the writing information, a reading processing module 16h executes transfer processing, etc., of reading information.

Further, the controller 16 includes an erase processing module 16i. The erase processing module 16i executes erase processing of physical blocks in the flash memory 15.

The controller includes an address management module 16j. The address management module 16j integrally manages the addresses in a recorded area and non-recorded area in the flash memory 15 and the hard disk 13.

Further, the controller 16 includes a state determination module 16k. The state determination module 16k monitors the states of the rotation of the hard disk 13 and the states, etc., of the remaining amounts of the hard disk 13, the SDRAM 14 and the flash memory 15.

The controller 16 is provided with a priority order management module 16l. In conducting the writing processing of the data from the flash memory 15 to the hard disk 13, the priority order management module 16l integrally manages the processing so that the data is written to the hard disk 13 in order from recorded in the recording blocks with poor states on the flash memory 15.

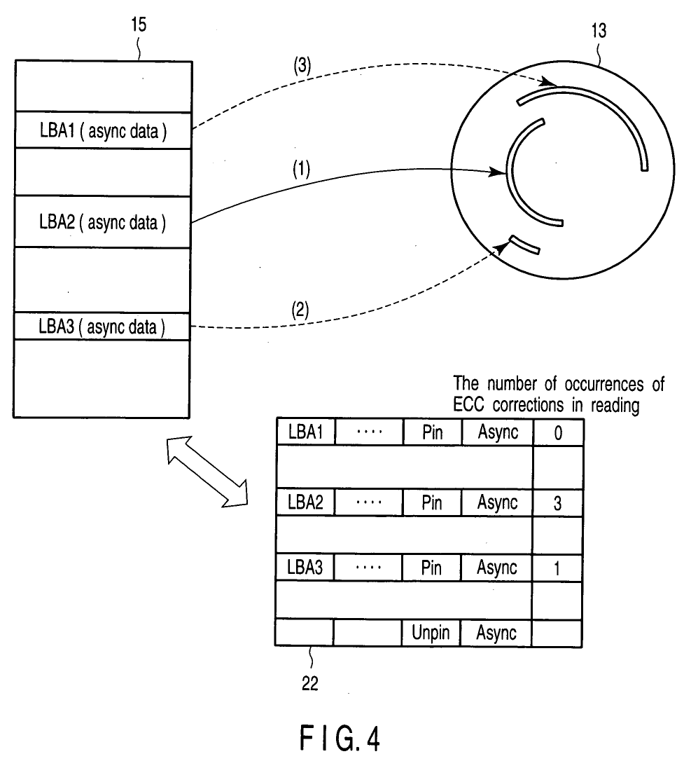

FIG. 4 shows an example of writing processing of the data, which is asynchronous (hereinafter abbreviated to async) data Flash memory, namely the data which does not coincide with the data recorded on the hard disk 13, on the hard disk 13 by placing a priority order for the data.

In other words, the flash memory 15 stores the data, which is (asynchronous) with the data on the hard disk 13, in areas LBA1, LBA2, LBA3, respectively. A management table 22 for managing the data recorded in the flash memory 15 is stored in the SDRAM 14, the flash memory 15, or a memory such as SRAM (not shown).

The management table 22 includes items indicating whether the currently pinned attribute information is added or whether the unpinned attribute information is added, items indicating whether or not the data recorded in the area is the data which is async with the data on the hard disk 13, items indicating the number of the ECC corrections in reading the data, etc.

When writing the data from the flash memory 15 to the hard disk 13, the priority order management module 16l of the controller 16 firstly refers to the management table 22 to detect the data which is async with the data on the hard disk 13. Here, three pieces of data recorded in each recording area corresponding to the LBA1-LB3 in the flash memory 15 are listed up as the async data.

After this, the priority order management module 16l refers to the management table for each recording area of the listed up three pieces of data to determine the number of occurrences of the ECC corrections at the time of data reading. In this case, in the area corresponding to the LBA1, the number of the ECC corrections in data reading is equivalent to 0 bits, in the area corresponding to the LBA2, the number of the ECC corrections in data reading is equivalent to 3 bits, and in the area corresponding to the LBA3, the number of the ECC corrections in data reading is equivalent to 1 bit.

Therefore, the priority order management module 16l sets the data in the area corresponding to the LBA2 in which the number of the ECC corrections in data reading as the data recorded in the recording area with the worst state, and places the priority order for the highest one, and in what follows, the priority order is placed in order from the data in the area corresponding to the LBA3 to the data in the area corresponding to the LBA1. The priority order management module 16l executes writing to the hard disk 13 in order of the data in the area corresponding to the LBA2, the data in the area corresponding to the LBA3, and the area corresponding to the LBA 1 on the basis of the placed priority order.

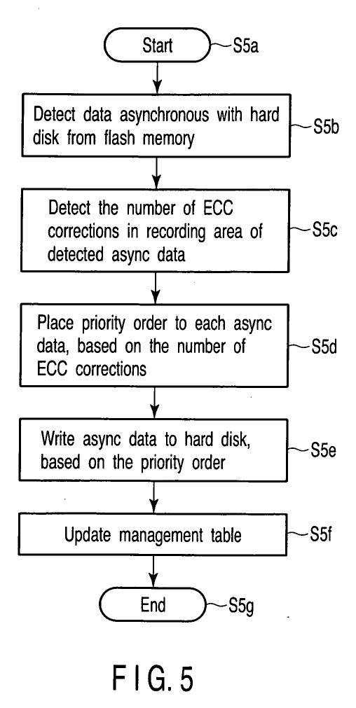

FIG. 5 shows a flowchart which illustrates an example of data writing processing operations from the flash memory 15 to the hard disk 13 performed by the priority order management module 16l. That is, when the processing starts (Step S5a), the priority order management module 16l refers to the management table 22 in Step S5b and detects data which is async with the data on the hard disk 13 among the data recorded in the flash memory 15.

After this, in Step S5c, the priority order management module 16l refers to the management table 22 for each recording area of each async data detected from the flash memory 15 in advance and detects the number of ECC corrections in data reading. Then, in step S5d, the priority order management module 16l determines a priority order for each async data detected from the flash memory 15 on the basis of the number of ECC corrections detected. The priority order management module 16l, in Step 5e, writes the async data in the flash memory 15 to the hard disk 13 on the basis of the previously placed priority order, updates the content in the management table 22 in Step S5f, and ends the processing (Step S5g).

While the processing operation shown in FIG. 4 has described that the priority order is placed on the basis of the number of ECC corrections for each async data detected from the flash memory 15, the invention is not limited to this. For example, placing the priority order only on the basis of the presence or absence of the ECC correction is a possible approach.

In this case, in FIG. 4, the data in each area corresponding to the LBA2 and LBA3 has the same priority order; the data is written in order of capability of being written to the hard disk 13. Like this, placing the priority order only on the basis of the presence or absence of the ECC correction enables adopting the placing in the case that the ECC correction ability is equivalent to one bit.

It is also possible for changing the placing in response to the recording area by placing the priority order on the basis of the number of the ECC corrections for each async data included in a predetermined recording area and placing the priority order on the basis of the presence or absence of the ECC correction for each async data included in other recording areas in the flash memory 15.

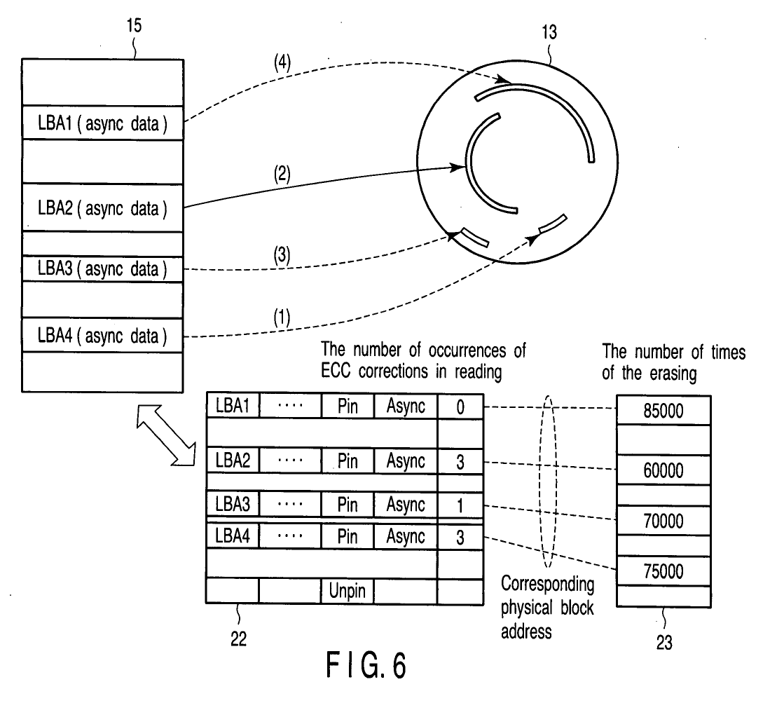

FIG. 6 shows an example of other writing processing for the data which is async with the data on the hard disk 13, namely the data which does not coincide with the data recorded on the hard disk 13 among the data recorded in the flash memory 15 by placing the priority order.

In other words, the data which is async with the data on the hard disk 13 is recorded, respectively, in each recording area corresponding to the LBA1, LBA2, LBA3 and LBA4. The management table 22 for managing the data recorded in the flash memory 15 is stored in the SDRAM 14 or the flash memory 15, or other memory such as SRAM.

The management table 22 includes an item indicating whether the currently pinned attribute information is added or the unpinned attribute information is added, an item indicating whether or not the data recorded in the area is async with the data on the hard disk 13, an item indicating the number of the ECC corrections in reading the data from the area, etc., for each recording area corresponding to each LBA set on the flash memory 15.

The management table of the times of the erasing 23 indicating the number of times of erasing physical blocks in the flash memory 15 is stored in the SDRAM 14 or the flash memory 15, or other memory such as SRAM. The number of times of erasing/writing is counted and recorded in the management table 23 for each recording area (physical block address) corresponding to each LBA set on the flash memory 15.

When writing the data from the flash memory 15 to the hard disk 13, the priority order management module 16l of the controller 16 firstly refers to the management table 22 to detect the data which is async with the data on the hard disk 13. Here, four pieces of data recorded in each recording area corresponding to the LBA1-LB4 in the flash memory 15 are listed up as async data.

After this, the priority order management module 16l refers to the management table 22 in relation to each recording area of the listed up four pieces of data and determines the number of occurrences of the ECC corrections in data reading. In this case, in the area corresponding to the LBA1, the number of the ECC corrections in data reading is equivalent to zero bits, in the area corresponding to the LBA2, the number of the ECC corrections in data reading is equivalent to three bits, in the area corresponding to the LBA3, the number of the ECC corrections in data reading is equivalent to one bit, and in the area corresponding to the LBA4, the number of the ECC corrections in data reading is equivalent to three bits.

In other words, in each area corresponding to the LBA2, LBA4, the numbers of the ECC corrections in data reading are equivalent to the largest three bits. At this moment, the priority order management module 16l refers to the management table regarding the number of times of the erasing 23 in each block corresponding to the LBA2 and LB4 to determine the number of times of the data writing. In this case, in the block corresponding to the LBA2, the number of times of the erasing is equivalent to 60 thousand, and in the block corresponding to the LB4, the number of times of the erasing is equivalent to 75 thousand.

Therefore, the priority order management module 16l recognizes the data in the area corresponding to the LBA4 in which the number of the ECC corrections in the data reading is the largest one and the number of times of the erasing is the largest one as the data recorded in the recording area with the worst state to place the highest priority order. Subsequently, priority orders are determined in order of the data corresponding to the LBA2, the data corresponding to the LBA3, and the data corresponding to the LBA1. For the rest, the priority order management module 16l executes writing to the hard disk 13 in order of the data in the area corresponding to the LBA4, the data in the area corresponding to the LBA2, the data in the area corresponding to the LBA3, and the data in the area corresponding to the LBA1, on the basis of the placed priority order.

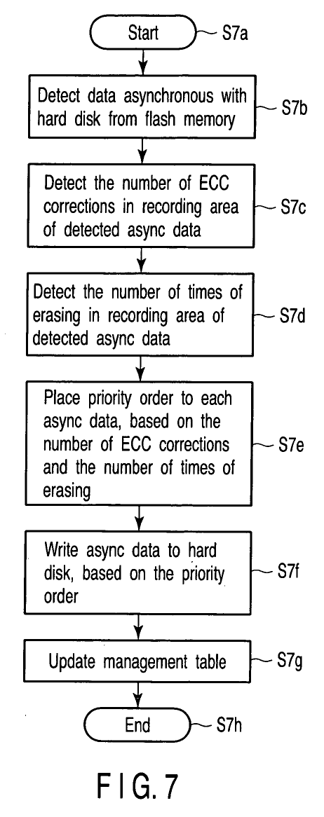

FIG. 7 shows a flowchart which illustrates other examples of the data writing processing operations from the flash memory 15 to the hard disk 13 by means of the priority order management module 16l. That is, when the processing is started (Step S7a), the priority order management module 16l refers to the management table 22 in Step S7b, to detect the data which is async with the data on the hard disk 13 from among the data recorded in the flash memory 15.

In Step S7c, the priority order management module 16l then refers to the management table 22 in relation to each recording area of each async data detected from the flash memory 15 in advance to detect the number of the ECC corrections in the data reading. The priority order management module 16l, in Step S7d, refers to the management table of the number of times of the erasing 23 in relation to each recording area of each async data to detect the number of times of the erasing.

The priority order management module 16l, in Step S7e, places priority order for each async data detected from the flash memory 15 on the basis of the number of the ECC corrections and the number of times of the erasing which have been detected in advance. Further, the priority order management module 16l, in Step S7f, writes the async data in the flash memory 15 to the hard disk 13 on the basis of the previously placed priority order, and in Step S7g, updates the content of the management table 22 to end the processing (Step S7h).

While the description of the processing operations shown in FIG. 6 relate to the case in which the number of ECC corrections are detected in advance, and high priority order is placed in the area with a large number of times of the erasing for the recording areas having the identical numbers of the ECC corrections, the invention is not limited to this case. It is needless to say that the high priority order may be placed to the area with a large number of ECC corrections in relation to the recording areas having an identical number of times of erasing.

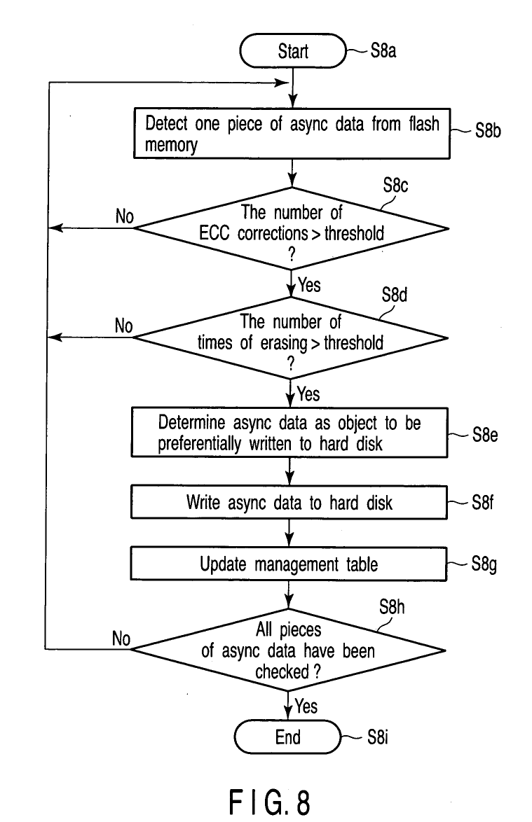

FIG. 8 shows a flowchart which illustrates further examples of placing priority order and of writing processing to the hard disk 13 for the data which is async with data on the hard disc 13.

While the example shown in FIGS. 4, 6 have described the case in which all the pieces of the async data are listed up from the flash memory 15 to place a priority order thereto, in the case in which the number of data registrations in the flash memory 15 becomes large, which results in an increase in async data, the processing becomes complicated. In these examples, thresholds are put to the number of the ECC corrections and the number of times of the erasing and writes the async data to the hard disk 13 in order of the async data which has exceeded the threshold.

That is, when the processing has started (Step S8a), the priority order management module 16l refers to the management table 22 in Step S8b, to detect one piece of data which is async with the data on the hard disk 13 from among the data recorded in the flash memory 15.

After this, the priority order management module 16l, in Step S8c, determines whether or not the number of the ECC corrections in the recording area of the detected async data exceeds the threshold preset for the ECC, namely whether or not an expression ‘the number of ECC corrections >threshold (for ECC)’ is established. If it is determined that the expression is not established (NO), the priority order management module 16l is returned to the processing in Step S8b, and executes to detect other data which has become async with the data on the hard disk 13 from among the data recorded in the flash memory 15.

In Step S8c, if it is determined that the number of ECC corrections exceeds the threshold (for ECC) (YES), the priority order management module 16l determines whether or not the number of times of erasing of the recording area of the detected async data exceeds the threshold preset for the number of times of the erasing in Step S8d, namely whether or not the expression ‘the times of erasing >threshold (for the number of times of erasing) is established. If it is determined that the expression is not established, the priority order management module 16l is returned to the processing in Step S8b, and executes to detect other data which becomes async with the data on the hard disk 13 from among the data recorded in the flash memory 15.

Conversely, in Step S8d, if it is determined that the number of times of the erasing exceeds the threshold (for the number of times of the erasing) (YES), the priority order management module 16l determines that the detected async data is an object to be written to the hard disk 13 preferentially in Step S8e, and executes to write the async data to the hard disk 13 in Step S8f, and updates the content in the management table 22 in Step S8g.

After this, the priority order management module 16l determines whether or not all the pieces of the async data recorded on the flash memory 15 have already completed the foregoing check in Step S8h, and if it is determined that the check has been completed (YES), the priority order management module 16l ends the processing (Step S8i). If it is determined that the check has not completed in Step S8h (NO), the priority order management module 16l is returned to Step S8b, and executes to detect other data which has become async with the data on the hard disc 13 from among the data recorded in the flash memory 15.

According to an example shown in FIG. 8, when one piece of async data is detected from the flash memory 15, and if both the number of the ECC corrections and the number of times of the erasing in the detected async data exceed the preset threshold, since the async data is repeatedly written preferentially to the hard disk 13, the information recording device may easily apply data detection even when the number of data registrations in the flash memory 15 becomes large and the volume of the async data becomes large.

In the example shown in FIG. 8, after completing the entire processing to write the async data in the recording area, in which the number of the ECC corrections and the number of times of the erasing exceed the threshold, to the hard disk 13, the information recording device may write the async data in the recording area in which the number of the ECC corrections and the number of times of the erasing do not exceed the thresholds to the hard disk 13. In this case, for the recording area in which the number of the ECC corrections and the number of times of the erasing do not exceed the thresholds, the processing to place the priority order described in FIGS. 4, 6 may be adopted.

Further, while the example shown in FIG. 8 has described the case in which when both the number of the ECC corrections and the number of times of the erasing in the recording blocks of the async data exceed the threshold, the async data is preferentially written to the hard disk 13, the invention is not limited to this case, and, for example, when either the number of the ECC corrections or the number of times of the erasing in the recording block of the async data exceeds the threshold, the async data may preferentially be written to the hard disk 13.

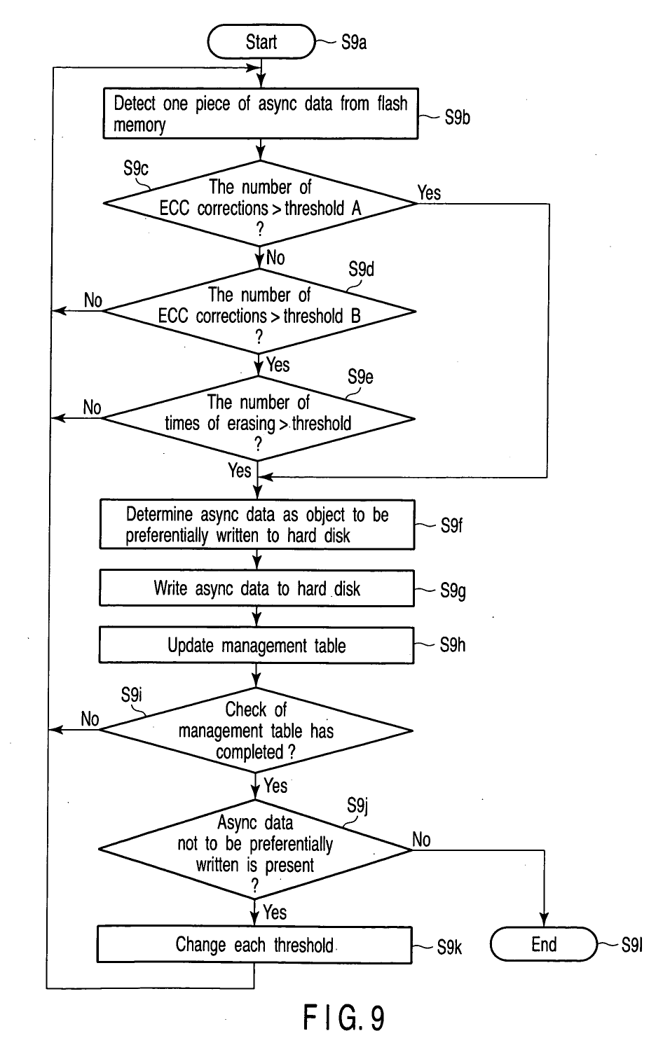

FIG. 9 shows a flowchart in which further examples in which the priority order is placed to the data which is async with the data on the hard disk 13 to write the data to the hard disk 13 from among the data recorded in the flash memory 15 are put together.

That is, when the processing starts (Step S9a), the priority order management module 16l refers to the management table 22 in Step S9b to detect one piece of data that is async with the data on the hard disk 13 from among the data recorded in the flash memory 15.

The priority order management module 16l then determines whether or not the number of the ECC corrections in the detected recording area of the async data, namely whether or not an expression ‘the number of ECC corrections >a threshold A (for ECC)’ is established in Step S9c. If it is determined that the expression is not established (NO), the priority order management module 16l determines, in Step S9d, whether or not the number of the ECC corrections in the recording area of the detected async data exceeds a threshold B which is smaller than the threshold A preset for the ECC.

If it is determined that the expression is not established (NO), the priority order management module 16l is returned to Step S9b, and executes to detect other data which is async with the data on the hard disk 13 from among the data recorded in the flash memory 15.

If it is determined that the expression is established, (YES), the priority order management module 16l determines, in Step S9e, whether or not the number of times of the erasing exceeds the threshold preset for the number of times of the erasing, namely whether an expression ‘number of times of the erasing >threshold (for the number of times of the erasing)’ is established or not in Step S9e. If it is determined that the expression is not established (NO), the priority order management module 16l is returned to the processing in Step S9b, and executes to detect other data which is async with the data on the hard disk 13 from among the data recorded in the flash memory 15.

Conversely, if it is determined that expression is established (YES), or it is determined that the number of the ECC corrections exceeds the threshold A in Step S9c (YES), the priority order management module 16l determines that the detected async data is the data to be preferentially written to the hard disk 13 in Step S9f, executes the writing the async data to the hard disk 13 in Step S9g, and updates the content in the management table 22 in Step S9h.

The priority order management module 16l then determines whether or not the entire management table has been checked in Step S9i. If it is determined that the management table has not checked entirely (NO), the priority order management module 16l is returned to Step S9b, and executes to detect other data which has become async with the data on the hard disk 13 from among the data recorded in the flash memory 15.

If it is determined that the management table has been entirely checked in Step S9i (YES), the priority order management module 16l determines whether or not the async data which has been determined not to be preferentially written is present in the flash memory 15 in Step S9j, and if it is determined that the async data is not present (NO), the priority order management module 16l ends the processing (Step S9l).

If it is determined that the async data is present in Step S9j (YES), the priority order management module 16l changes the threshold A (for ECC), threshold B (for ECC) and threshold (for erasing) in Step S9k, then is returned to Step S9b, and executes to detect again the data which has become async with the data on the hard disk 13 from among the data recorded in the flash memory 15.

According to the example shown in FIG. 9, since two kinds of thresholds, A, B, for comparison of the numbers of the ECC are set, and determination is made of the async data in the recording area in which the number of the ECC corrections exceeds the larger threshold A is the async data to be written to the hard disk unconditionally without having to determine the number of times of the erasing, the processing may be accelerated.

For instance, if ECC correction ability is equivalent to five bits, when the threshold A is set to four bits, and the threshold B is set to two bits, since the async data in the recording area of which the number of the ECC corrections exceeds four bits is unconditionally determined as an object to be preferentially written to the hard disk 13 without having to determine the number of times of the erasing, the determination processing may be accelerated.

When the processing to detect the async data for the management table 22 makes a circuit, if the async data being determined to be not the target of preferential writing is present in the flash memory 15, since the priority order management module 16l changes the threshold value A (for ECC), threshold B (for ECC) and threshold (for erasing) and re-detects the async data from the flash memory 15, the priority order management module 16l may place priority order to the async data in a further strict manner.

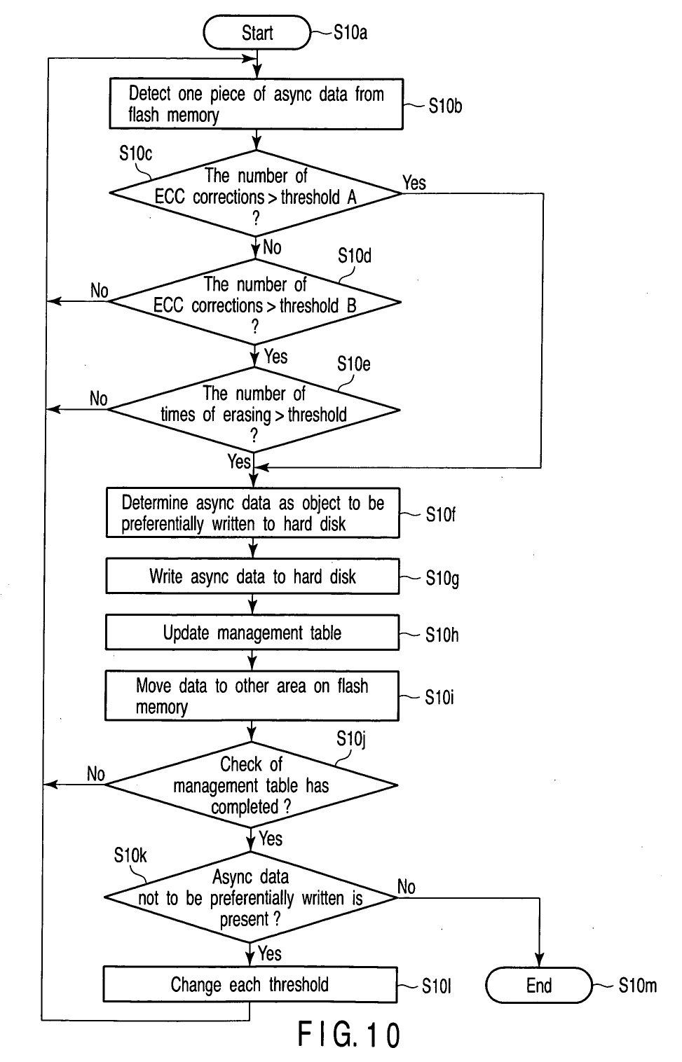

FIG. 10 shows a flowchart which illustrates further examples of the processing for writing the data which is async with the data on the hard disk 13 by placing priority order from among the data recorded in the flash memory 15.

That is, when the processing is started (Step S10a), the priority order management module 16l refers to the management table 22 to detect one piece of data which has been async with the data on the hard disk 13 from among the data recorded in the flash memory 15 in Step S10b.

After this, the priority order management module 16l determines whether or not the number of the ECC corrections in the recording area of the detected async data exceeds the threshold A preset for the ECC, namely whether or not an expression ‘the number of ECC corrections >a threshold A (for ECC)’ is established in Step S10c. If it is determined that the expression is not established (NO), the priority order management module 16l determines whether or not the number of the ECC corrections in the recording area of the detected async data exceeds the threshold B which is smaller than the threshold A preset for the ECC, that is, an expression ‘the number of ECC corrections >the threshold B (for ECC)’ is established in Step S10d.

If it is determined that the expression is not established (NO), the priority order management module 16l is returned to the processing in Step S10b to detect other data which has been async with the data on the hard disk 13 from among the data recorded in the flash memory 15.

If it is determined that the number of ECC corrections exceeds the threshold B (for ECC) (YES), the priority order management module 16l determines whether or not the number of times of the erasing in the recording block of the detected async data exceeds the threshold which is preset for the number of times of the erasing, namely an expression ‘number of times of the erasing >a threshold (for number of times of the erasing)’ is established in Step S10e. If it is determined that the expression is not established (NO), the priority order management module 16l is returned to the processing in Step S10b, and executes to detect other data which has been async with the data on the hard disk 13.

Conversely, if it is determined that the number of number of times of the erasing exceeds the threshold (for the number of times of the erasing) in Step S10e (YES), or if the number of ECC corrections exceeds the threshold A in Step S10c (YES), the priority order management module 16l determines that the detected async data is an object to be preferentially written to the hard disk 13 in Step S10f, executes to write the async data to the hard disk 13 in Step S10g, and updates the content of the management table 22 in Step S10h.

If it is determined that it is needed for the data which has been written from the flash memory 15 to the hard disk 13 to be stored in the flash memory 15, the priority order management module 16l shifts the data to another recording area in the flash memory 15 to protect the data in Step S10i. In this case, as regards the recording area to be the shift destination of the data, an area in which the number of the ECC corrections and the number of times of the erasing are smaller than those in the recording area before the shifting is selected.

The priority order management module 16l then determines whether or not the management table is entirely checked in Step S10j, and if it is determined the management table has not been entirely checked (NO), the priority order management module 16l is returned to the processing in Step S10b, and executes to detect other data which has become async with the data on the hard disk 13 from among the data recorded in the flash memory 15.

If it is determined that the management table has been entirely checked in Step S10j (YES), the priority order management module 16l determines whether or not the async data which has been determined as the data to be preferentially written is present in the flash memory 15 in Step S10k, and if it is determined that the data is not present therein (NO), the priority order management module 16l ends the processing (Step S10m).

If it is determined that the data is present in Step S10k, (YES), the priority order management module 16l changes the threshold A (for ECC), threshold B (for ECC) and threshold (for erasing) in Step S10l, is returned to the processing Step S10b, and executes to re-detect the data which has become async with the data on the hard disk 13 from among the data recorded in the flash memory 15.

According to an example shown in FIG. 10, after writing the async data from the flash memory 15 to the hard disk 13, if it is needed for the data to be stored in the flash memory 15, since the data is shifted to the other recording area in the flash memory 15, the data is prevented from being left in the recording area of which the state is poor in the flash memory 15, and the data may be protected.

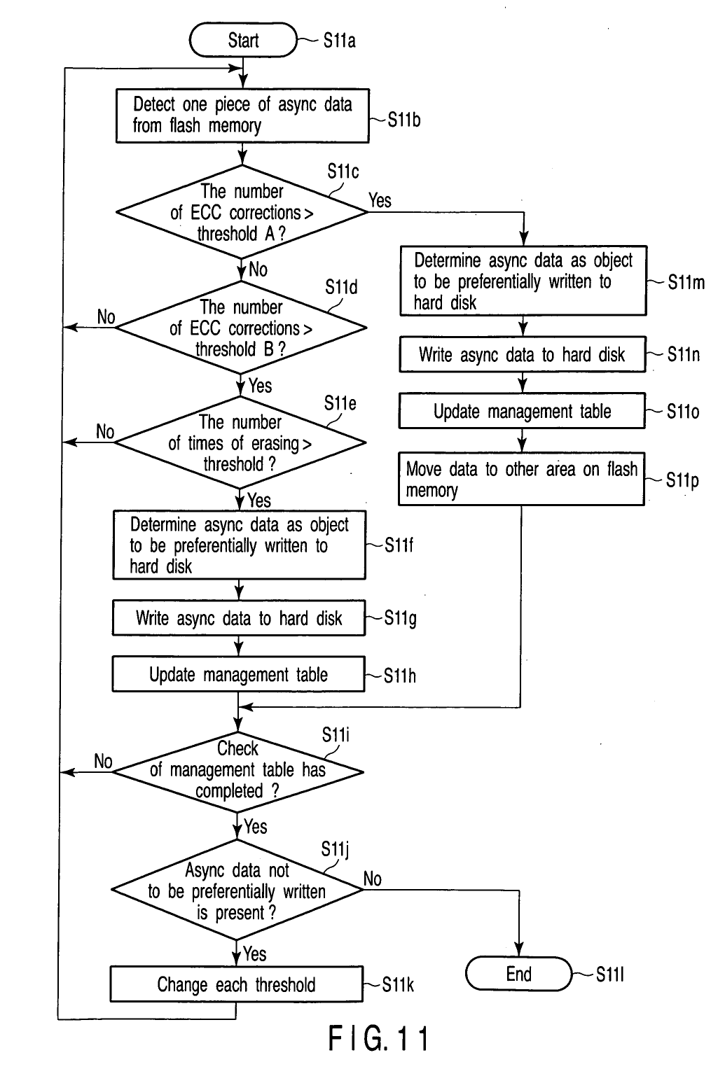

FIG. 11 shows a flowchart which illustrates further examples of processing to place priority order to the data which has been async with the data on the hard disk 13 from among the data recorded in the flash memory 15 to write to the hard disk 13.

That is, when the processing starts (Step S11a), the priority order management module 16l refers to the management table 22 in Step S11b, and detects one item of data which has been async with the data on the hard disk 13 from among the data recorded in the flash memory 15.

After this the priority order management module 16l determines whether or not the number of the ECC corrections in the recording area of the detected async data exceeds the threshold A preset for the ECC, namely whether or not an expression ‘the number of ECC corrections >the threshold A (for ECC)’ is established, in Step S11c. If it is determined that the expression is not established (NO), the priority order management module 16l determines whether or not the number of the ECC corrections in the recording area of the detected async data exceeds the threshold B which is smaller than the threshold A that is preset for the ECC, namely whether or not an expression ‘the number of ECC corrections >the threshold B (for ECC)’ is established in Step S11d.

Here, if it is determined that the number does not exceed the threshold B (NO), the priority order management module 16l is returned to the processing in Step S11b, and executes to detect other data which has been async with the data on the hard disk 13 from among the data recorded in the flash memory 15.

If it is determined that the number of the ECC corrections exceeds the threshold B (for ECC) in Step S11d (YES), the priority order management 16l determines whether or not the number of times of the erasing in the recording block of the detected async data exceeds the threshold which is preset for the number of times of the erasing, namely an expression ‘the number of times of the erasing >the threshold (for the number of times of the erasing)’ is established in Step S11e. If it is determined that the expression is not established (NO), the priority order management module 16l is returned to Step S11b, and executes to detect other data which has become async with the data on the hard disk 13 from among the data recorded in the flash memory 15.

Conversely, if it is determined that the number of times of the erasing exceeds the threshold (for the number of times of the erasing) in Step S11e (YES), the priority order management module 16l determines that the detected async data as an object to be preferentially written to the hard disk 13 in Step S11f, executed to write the async data to the hard disk 13 in Step S11g, and updates the content in the management table 22 in Step S11h.

The priority order management module 16l then determines whether or not the management table 22 has been entirely checked in Step S11i. If it is determined that the management table 22 has not been entirely checked (NO), the priority order management module 16l is returned to the processing in Step S11b, and executes to detect other data which has been async with the data on the hard disk 13 from among the data recorded in the flash memory 15.

If it is determined that the management table 22 has been entirely checked in Step S11i (YES), the priority order management module 16l determines whether or not the async data which has been determined to be not a preferential object is present in the flash memory 15 in Step S11j, and if it is determined that such data is not present (NO), the priority order management module 16l ends the processing (Step S11l).

If it is determined that such data is present in Step S11j (YES), the priority order management module 16l changes the threshold A (for ECC), threshold B (for ECC) and threshold (for erasing) in Step S11k then executes to re-detect the data which has become async with the data on the hard disk 13 from among the data recorded in the flash memory 15.

On the contrary, if it is determined that the number of the ECC corrections exceeds the threshold A in Step S11c (YES), the priority order management 16l determines that the detected async data as an object to be preferentially written to the hard disk 13 in Step Slim, executes to written the async data to the hard disk 13 in Step 11n, and updates the content in the management table 22 in Step S11o.

If it is determined that the data which has been written from the flash memory 15 to the hard disk 13 has to be stored in the flash memory 15 in Step Slip, the priority order management 16l moves the data to another recording area in the flash memory 15 to protect the data, and shifts to the processing in Step S11i. In this case, as regards the recording area to be the moving destination of the data, an area with a smaller number of the ECC corrections and of the number of times of the erasing in comparison with the recording block before moving the data is selected.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information recording device comprising:
a nonvolatile memory configured to serve as a cache for a disk-like recording medium;
a control module configured to control data transfer between the disk-like recording medium and the nonvolatile memory; and
a setting module configured to detect a priority order in accordance with a state of recording areas of the nonvolatile memory in which the predetermined data is recorded.

2. The information recording device according to claim 1, wherein the control module is configured to control data transfer among the disk-like recording medium, the nonvolatile memory and an external device.

3. The information recording device according to claim 1, wherein the predetermined data is asynchronous data which is recorded in the nonvolatile memory and which is not recorded in the disk-like recording medium.

4. The information recording device according to claim 1, wherein the setting module is configured to detect an error correction is made at the time of reading out data with respect to each of the recording areas of the nonvolatile memory in which the predetermined data is recorded.

5. The information recording device according to claim 1, wherein the setting module is configured to detect how many error corrections are made at the time of reading out data with respect to each of the recording areas of the nonvolatile memory in which the predetermined data is recorded, and is configured to detect a priority order such that data recorded in a recording area about which many error corrections are detected is written in the disk-like recording medium in preference to other data.

6. The information recording device according to claim 1, wherein the setting module is configured to detect how many times erasing has occurred in each physical block of the nonvolatile memory in which the predetermined data is recorded, and is configured to detect a priority order such that data recorded in a recording area for which erasing has been performed many times is written in the disk-like recording medium in preference to other data.

7. The information recording device according to claim 1, wherein the setting module compares, with a predetermined threshold value, the number of error corrections made at the time of reading out data with respect to each of the recording areas of the nonvolatile memory in which the predetermined data is recorded with a threshold value, and is configured to detect a priority order such that data recorded in a recording area whose number of data corrections is larger than the threshold value is written in the disk-like recording medium in preference to other data.

8. The information recording device according to claim 1, wherein the setting module compares, with a predetermined threshold value, the number of times erasing has occurred in each of the physical block of the nonvolatile memory in which the predetermined data is recorded, and is configured to detect a priority order such that data recorded in a recording area whose erasing times is larger than the threshold value is written in the disk-like recording medium in preference to other data.

9. The information recording device according to claim 1, wherein the control module is configured to write the predetermined data in different ones of the recording areas of the nonvolatile memory in accordance with the state of the recording areas of the nonvolatile memory in which the predetermined data is recorded, in a state where the predetermined data recorded in the nonvolatile memory has been written in the disk-like recording medium.

10. A hard disk drive comprising:
a nonvolatile memory configured to serve as a cache for a hard disk;
a control module configured to control data transfer between the hard disk and the nonvolatile memory; and
a setting module configured to detect a priority order in accordance with a state of recording areas of the nonvolatile memory in which the predetermined data is recorded.

11. The hard disk device according to claim 10, wherein the control module is configured to control data transfer among the hard disk, the nonvolatile memory and an external device.

12. A control method for use in an information recording device comprising:
controlling data transfer between a disk-like recording medium and a nonvolatile memory; and
setting a priority order in accordance with a state of recording areas of the nonvolatile memory in which the predetermined data is recorded.

13. The control method for use in an information recording device according to claim 12, wherein the controlling data transfer among the disk-like recording medium, the nonvolatile memory and an external device.
